(19) United States
(12) Patent Application Publication
(10) Pub. No.: US 2021/0060623 A1
(43) Pub. Date: Mar. 4, 2021

(54) CLEANING DEVICE FOR RESIDUE IN DRUM OF WASHING MACHINE

(71) Applicant: CHOI TIM TAM, HONG KONG (CN)

(72) Inventor: CHOI TIM TAM, HONG KONG (CN)

(21) Appl. No.: 17/002,801

(22) Filed: Aug. 26, 2020

(30) Foreign Application Priority Data
Sep. 4, 2019 (CN) 201910833118.5

(51) Int. Cl. B08B 3/12; B08B 9/08

(52) U.S. Cl. CPC B08B 3/12; B08B 9/0817; B08B 2209/08; B08B 2209/005; B08B 9/0821

(57) ABSTRACT

The application provides a cleaning device for residue in a washing machine, comprising a work table, a cleaning tank, an ultrasonic device and a placing basket. The work table comprises a bottom and a side; the cleaning tank is installed in the work table, and a heating rod is installed in the cleaning tank; the ultrasonic device is installed at the outer wall of the cleaning tank; and a mesh is defined in a side wall of the placing basket which is able to enter inside of the cleaning tank through an opening.

### TECHNICAL FIELD

The application relates to a technical field of a drum cleaning for a washing machine, in particular to a cleaning device for residue in a drum of the washing machine.

### BACKGROUND ART

Residues often remain on a drum of a washing machine after use, and a normal operation of the washing machine will be affected if the residues are not cleaned for a long time, therefore it is necessary to clean the drum of the washing machine after a certain period of time.

### SUMMARY

An embodiment of this application aims to provide a cleaning device for residue in a drum of a washing machine, which can effectively clean the drum of the washing machine.

Embodiments of the application can be realized as follows:

A cleaning device for residue in a drum of a washing machine is provided in an embodiment of this application, which comprises a work table, a cleaning tank, an ultrasonic device and a placing basket. The work table comprises a bottom and a side, wherein the bottom and the side enclose a groove structure with an accommodating chamber, the groove structure being provided with a first opening;

The cleaning tank is installed in the groove structure and connected with the bottom of the work table through a connecting assembly, and a heating rod is installed in the cleaning tank; the ultrasonic device is installed at the bottom of the outer wall of the cleaning tank; and a second opening is provided on a top of the cleaning tank;

an upper surface of the side is connected with a connecting frame, an end of the connecting frame is fixedly connected with the upper surface of the side through a fixing block, the connecting frame is arranged on the two opposite sides and the connecting frames on the two opposite sides are connected through a connecting plate, a lower surface of the connecting plate is fixedly connected with a placing seat, a lower surface of the placing seat is fixedly connected with a hydraulic cylinder, an output end of the hydraulic cylinder is fixedly connected with a hydraulic rod, an end of the hydraulic rod is fixedly connected with an motor housing in which a motor is fixedly connected, an output end of the motor is fixedly connected with a fixing seat, a bottom end of the fixing seat is fixedly connected with a damping spring, a bottom end of the damping spring is fixedly connected with a placing basket, a mesh is defined in a side wall of the placing basket, and the placing basket can enter the cleaning tank from the second opening.

In a possible embodiment, the connecting assembly comprises a supporting block, a supporting rod and a backing plate, wherein the supporting block is fixedly connected with the bottom of the work table, the backing plate is connected with the outer wall of the cleaning tank, and two ends of the supporting rod are respectively connected with the supporting block and the backing plate.

In a possible embodiment, the connecting assembly further comprises a connecting block and a connecting rod arranged on two opposite sides of the cleaning tank, wherein the connecting block is fixedly connected with the outer wall of the cleaning tank, and two opposite ends of the connecting rod are respectively connected with the connecting block and the connecting rod.

In a possible embodiment, the ultrasonic device comprises an ultrasonic generator, wherein a side of the ultrasonic generator is fixedly connected with an ultrasonic conduction tube, an end of the ultrasonic conduction tube is fixedly connected with an ultrasound transducer, the ultrasonic generator being fixedly installed on the bottom of the work table and the ultrasonic transducer being installed on the outer wall of the cleaning tank.

In a possible embodiment, an outer wall of the bottom of the work table is fixedly connected with a foot.

In a possible embodiment, a diameter of the mesh is 3-5 centimeters.

The cleaning device for residue in a drum of a washing machine according to embodiments of the application at least comprises the following advantageous effects:

when a user places a drum of the washing machine in the placing basket, the placing basket can be controlled to rise and fall by the hydraulic cylinder, and when the placing basket is controlled to fall into the cleaning tank by the hydraulic cylinder, it can be ensured by the placing basket that the drum of the washing machine will not cause any mechanical loss to the cleaning tank when shaking; water in the cleaning tank can be heated by a heater, and an ultrasonic generated by the ultrasonic device can bring a strong vibration to the solvent in the cleaning tank, thus increasing a contact strength between the solvent and the drum of the washing machine, which will clean some dead spaces in the drum of the washing machine and thus guarantee a good cleaning effect; after washing, the placing basket can be controlled to rise out of the cleaning tank by the hydraulic cylinder, and the user can take out the drum of the washing machine from the placing basket.

### BRIEF DESCRIPTION OF DRAWINGS

In order to illustrate technical schemes of embodiments of this application more clearly, the following drawings used in the embodiments will be briefly introduced; it should be understood that the following drawings only show some embodiments of this application, therefore they should not be regarded as a limiting of the protection scope; and other related drawings can be obtained according to these ones without creative effort for ordinary skilled in the art.

FIG. 1 is a structural schematic diagram of a cleaning device for residue in a drum of a washing machine according to an embodiment of the application;

FIG. 2 is a structural schematic diagram of an ultrasonic device according to an embodiment of the application.

Reference Number: 1—Work Table; 2—Foot; 3—Support Block; 4—Support Rod; 5—Backing Plate; 6—Cleaning Tank; 7—Connecting Block; 8—Connecting Rod; 9—Heating Rod; 10—Ultrasonic Device; 101—Ultrasonic Generator; 102—Ultrasonic Conduction Tube; 103—Ultrasonic Transducer; 11—Fixing block; 12—Connecting Frame; 13—Connecting Plate; 14—Placing Seat; 15—Hydraulic Cylinder; 16—Hydraulic Rod; 17—Motor Housing; 18—Motor; 19—Fixing Seat; 20—Damping Spring; 21—Placing Basket.

### DETAILED DESCRIPTION OF PREFERRED EMBODIMENTS

In order to make the purposes, technical schemes and advantages of embodiments of this application more clear, the technical schemes in the embodiments of this application will be described clearly and completely with reference to the drawings in the embodiments of this application; and it is Obvious that the described embodiments are part of the embodiments of this application, but not all of them. The components of the embodiments of the application generally described and illustrated in the drawings herein can be arranged and designed in various different configurations.

Therefore, the following detailed description of the embodiments of the application provided in the drawings is not intended to limit the claimed scope of the application, but only shows selected embodiments of the application. On a basis of the embodiments in this application, all other embodiments obtained by the ordinary skilled in the art without any creative effort are within the protection scope of this application.

It should be noted that similar reference numerals and letters indicate similar items in the following figures, thus once an item is defined in one figure, it is not necessary to further define and explain it in subsequent figures.

In the description of this application, it should be noted that the orientation or position relationships indicated by the terms such as “upper”, “lower”, “left”, “right”, “inner” and “outer” are based on the orientation or position relationships shown in the drawings, or the generally adopted orientation or position relationships when the products of this application are used are only for convenience of describing this application and for simplifying the description, but do not indicate or imply that the referred device or element must have a specific orientation, be constructed and operated in a specific orientation, and therefore cannot be understood as a limitation of this application. In addition, the terms “first”, “second”, “third”, etc. are only used to distinguish descriptions, and cannot be understood as indicating or implying a relative importance.

In the description of this application, it should also be noted that unless otherwise specified and limited, the terms “providing”, “installing” and “connecting” should be understood in a broad sense, for example, it can be “fixedly connecting”, or “detachably connecting” or “integrally connecting”, or it can be “mechanically connecting” or “electrically connecting”, or it can be “directly connecting” or “indirectly connecting through an intermediate medium”, or it can be “communicating within two elements”. For those ordinary skilled in the art, the specific meanings of the above terms in this application can be understood according to specific situations.

Some embodiments of this application will be described in detail with reference to the drawings.

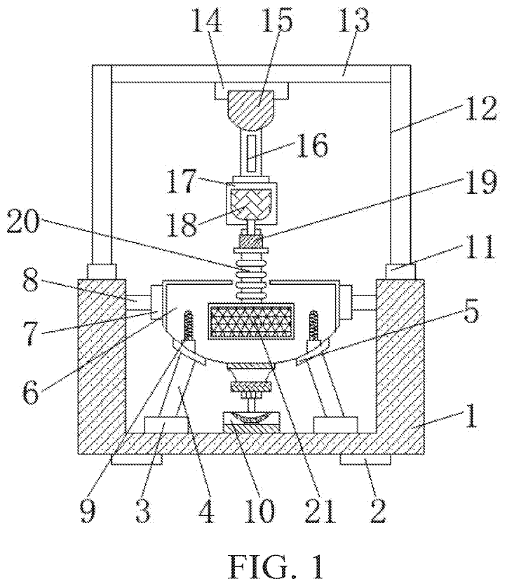

Referring to FIG. 1, a cleaning device for residue in a drum of a washing machine is provided in this embodiment, which includes a work table 1, a cleaning tank 6, an ultrasonic device 10 and a placing basket 21.

The work table 1 includes a bottom and a side, in which the bottom and the side enclose a groove structure with an accommodating chamber, the groove structure being provided with a first opening. Illustratively, an outer wall of the bottom of the work table 1 is fixedly connected with a foot 2 which is used for supporting the work table 1; and it should be noted that the foot 2 may not be provided.

The cleaning tank 6 is installed in the groove structure, that is, the cleaning tank 6 is installed in an accommodating chamber. The cleaning tank 6 is connected with the bottom of the work table 1 through a connecting assembly, and there is a gap between the bottom of the outer wall of the cleaning tank 6 and the bottom of the work table 1, and a second opening is provided on the top of the cleaning tank 6.

A heating rod 9 is installed in the cleaning tank 6; and the ultrasonic device 10 is installed at the bottom of the outer wall of the cleaning tank 6.

An upper surface of the side is connected with a connecting frame 12, an end of the connecting frame 12 is fixedly connected with the upper surface of the side through a fixing block 11, the connecting frames 12 are arranged on these two opposite sides and the connecting frames 12 on these two opposite sides are connected through a connecting plate 13, a lower surface of the connecting plate 13 is fixedly connected with a placing seat 14, a lower surface of the placing seat 14 is fixedly connected with a hydraulic cylinder 15, an output end of the hydraulic cylinder 15 is fixedly connected with a hydraulic rod 16, an end of the hydraulic rod 16 is fixedly connected with an motor housing 17. The hydraulic cylinder 15 can drive the hydraulic rod 16 to rise and fall, thus driving the motor housing 17 to rise and fall.

The motor 18 is fixedly connected in the motor housing 17, an output end of the motor 18 is fixedly connected with a fixing seat 19, a bottom end of the fixing seat 19 is fixedly connected with a damping spring 20, a bottom end of the damping spring 20 is fixedly connected with a placing basket 21, a mesh is provided in a side wall of the placing basket 21, and the placing basket 21 can enter the cleaning tank 6 from the second opening. The rising and falling of the motor box 17 can drive the placing basket 21 to rise and fall, and the motor 18 can drive the placing basket 21 to rotate.

During use, a drum of the washing machine is placed in the placing basket 21, the placing basket 21 can be controlled to rise and fall by the hydraulic cylinder 15, and when the placing basket 21 is controlled to fall into the cleaning tank 6 by the hydraulic cylinder 15, it can be ensured by the placing basket 21 that the drum of the washing machine will not cause any mechanical loss to the cleaning tank 6 when shaking; water in the cleaning tank 6 can be heated by a heater, and an ultrasonic generated by the ultrasonic device 10 can bring a strong vibration to the solvent in the cleaning tank 6, thus increasing a contact strength between the solvent and the drum of the washing machine, which will clean some dead spaces in the drum of the washing machine and thus guarantee a good cleaning effect. After washing, the placing basket 21 can be controlled by the hydraulic cylinder 15 to rise away from the cleaning tank 6, and the motor 18 moves to drive the placing basket 21 to rotate, so that washing liquid remained on the drum of the washing machine after washing can be dried, preventing the washing liquid from dripping to the ground and causing the workers to slip, and then the user can take out the drum of the washing machine from the placing basket 21.

Further, a diameter of the mesh defined in the side wall of the placing basket 21 is 3-5 centimeters, which can prevent parts inside the drum of the washing machine from falling out of the placing basket 21 during cleaning.

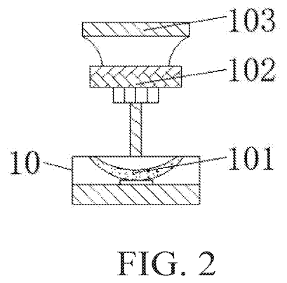

In addition, please refer to FIG. 2, the ultrasonic device 10 includes an ultrasonic generator 101, a side of the ultrasonic generator 101 is fixedly connected with an ultrasonic conduction tube 102, an end of the ultrasonic conduction tube 102 is fixedly connected with an ultrasound transducer 103, the ultrasonic generator 101 being fixedly installed at the bottom of the work table 1 and the ultrasonic transducer 103 being installed on the outer wall of the cleaning tank 6.

An ultrasonic wave generated by the ultrasonic generator 101 can be transmitted to the ultrasonic transducer 103 through the ultrasonic conduction tube 102, so that the ultrasonic transducer 103 generates a vibration to drive the cleaning tank 6 to vibrate. The ultrasonic wave presents a best cleaning effect when the cleaning solution is at 50-70° C.; by way of example, the heating rod 9 is used to heat the water in the cleaning tank 6 to 50-70° C.

The connecting assembly includes a supporting block 3, a supporting rod 4 and a backing plate 5, in which the supporting block 3 is fixedly connected with the bottom of the work table 1, the backing plate 5 is connected with the outer wall of the cleaning tank 6, and two ends of the supporting rod 4 are respectively connected with the supporting block 3 and the backing plate 5. The cleaning tank 6 can be fixedly connected with the bottom of the work table 1 through the support block 3, the support rod 4 and the backing plate 5.

Further, the connecting assembly further includes a connecting block 7 and a connecting rod 8 arranged on two opposite sides of the cleaning tank 6, in which the connecting block 7 is fixedly connected with the outer wall of the cleaning tank 6, and two opposite ends of the connecting rod 8 are respectively connected with the connecting block 7 and the connecting rod 8. The cleaning tank 6 is fixedly connected with the side of the work table 1 through the connecting block 7 and the connecting rod 8, so that the cleaning tank 6 can be more stably installed in the groove structure.

The above is only preferred embodiments of this application, and is not intended to limit this application, and modifications and variations can be made in this application for those skilled in the art. Any modification, equivalent substitution, improvement, etc. made within the spirit and principle of this application shall be encompassed within the protection scope of this application.

What is claimed:

1. A cleaning device for residue in a drum of a washing machine, wherein it comprises a work table, a cleaning tank, an ultrasonic device and a placing basket, wherein the work table comprises a bottom and a side, and the bottom and the side enclose a groove structure with an accommodating chamber, and the groove structure being provided with a first opening;
the cleaning tank is installed in the groove structure and connected with the bottom of the work table through a connecting assembly, and a heating rod is installed in the cleaning tank; the ultrasonic device is installed at the bottom of the outer wall of the cleaning tank; and a second opening is provided on a top of the cleaning tank;
an upper surface of the side is connected with a connecting frame, an end of the connecting frame is fixedly connected with the upper surface of the side through a fixing block, the connecting frame is arranged on the two opposite sides and the connecting frames on the two opposite sides are connected through a connecting plate, a lower surface of the connecting plate is fixedly connected with a placing seat, a lower surface of the placing seat is fixedly connected with a hydraulic cylinder, an output end of the hydraulic cylinder is fixedly connected with a hydraulic rod, an end of the hydraulic rod is fixedly connected with an motor housing in which a motor is fixedly connected, an output end of the motor is fixedly connected with a fixing seat, a bottom end of the fixing seat is fixedly connected with a damping spring, a bottom end of the damping spring is fixedly connected with a placing basket, a mesh is defined in a side wall of the placing basket, and the placing basket can enter the cleaning tank from the second opening.

2. The cleaning device for residue in the drum of the washing machine according to claim 1, wherein the connecting assembly comprises a supporting block, a supporting rod and a backing plate, wherein the supporting block is fixedly connected with the bottom of the work table, the backing plate is connected with the outer wall of the cleaning tank, and two ends of the supporting rod are respectively connected with the supporting block and the backing plate.

3. The cleaning device for residue in the drum of the washing machine according to claim 2, wherein the connecting assembly further comprises a connecting block and a connecting rod arranged on two opposite sides of the cleaning tank, wherein the connecting block is fixedly connected with the outer wall of the cleaning tank, and two opposite ends of the connecting rod are respectively connected with the connecting block and the connecting rod.

4. The cleaning device for residue in the drum of the washing machine according to claim 1, wherein the ultrasonic device comprises an ultrasonic generator, wherein a side of the ultrasonic generator is fixedly connected with an ultrasonic conduction tube, an end of the ultrasonic conduction tube is fixedly connected with an ultrasound transducer, the ultrasonic generator being fixedly installed on the bottom of the work table and the ultrasonic transducer being installed on the outer wall of the cleaning tank.

5. The cleaning device for residue in the drum of the washing machine according to claim 1, wherein the bottom outer wall of the work table is fixedly connected with a foot.

6. The cleaning device for residue in the drum of the washing machine according to claim 1, wherein a diameter of the mesh is 3-5 centimeters.
